(19) United States
(12) Patent Application Publication
(10) Pub. No.: US 2012/0324722 A1
(43) Pub. Date: Dec. 27, 2012

(54) DISASSEMBLY DEVICE

(75) Inventors: TIAN-LEI WANG, Shenzhen City (CN); YONG-HUI HU, Shenzhen City (CN); KAI-KUEI WU, Tu-Cheng (TW); KUN-CHIH HSIEH, Tu-Cheng (TW); QING-QING ZHENG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/210,344

(22) Filed: Aug. 15, 2011

(30) Foreign Application Priority Data
Jun. 27, 2011 (CN) 201110174999.8

(51) Int. Cl. B23P 19/00

(52) U.S. Cl. 29/762

(57) ABSTRACT

A disassembling device includes a plate, a number of suction cups, a number of fasteners, and a number of rods. The suction cups and the fasteners are respectively disposed at opposite sides of the plate to the fasteners. The plate includes a number of through holes. Each of the rods is fixed to one of the suction cups, the rods extend through the respective through holes, and is connected to the respective fasteners.

### BACKGROUND

1. Technical Field

The present disclosure relates to a disassembly device, especially to a disassembly device for detaching covers from electronic devices.

2. Description of Related Art

During the manufacture of an electronic device including an upper cover and a lower cover, there may rise a need to detach the upper cover or the lower cover. For example, when needing to rework the device, the assembled upper cover may need to be detached. Because the upper cover and the lower cover are fixed to other members of the electronic device, an auxiliary tool for disassembling the upper cover and the lower cover is needed which is inconvenient.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an isometric view of a disassembly device according to an exemplary embodiment.

FIG. 2 is similar to FIG. 1, but viewed from a different viewpoint.

FIG. 3 is an exploded view of the disassembling device in FIG. 1.

FIG. 4 is similar to FIG. 3, but viewed from a different viewpoint.

FIG. 5 is a cross-sectional view taken along line V-V of FIG. 1.

### DETAILED DESCRIPTION

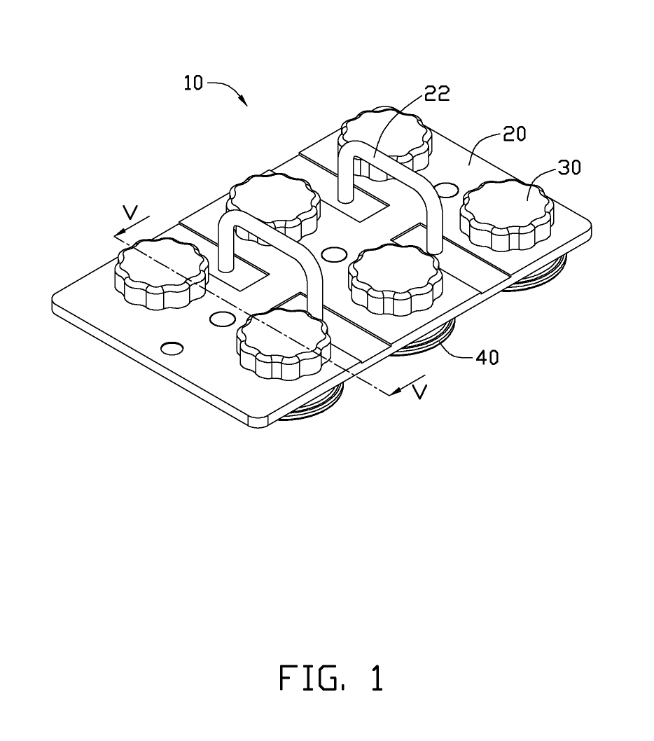

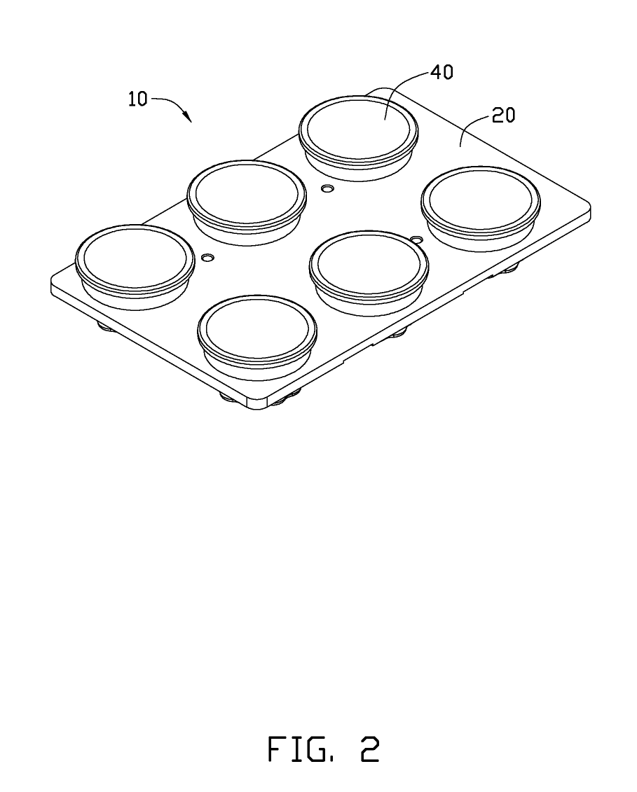

Referring to FIGS. 1 and 2, a disassembly device 10 according to an exemplary embodiment includes a plate 20, a number of fasteners 30, and a number of suction cups 40. The fasteners 30 and the suction cups 40 are respectively disposed at opposite sides of the plate 20. The plate 20 includes a handle 22 that can be gripped by an operator to push or pull the disassembly device 10.

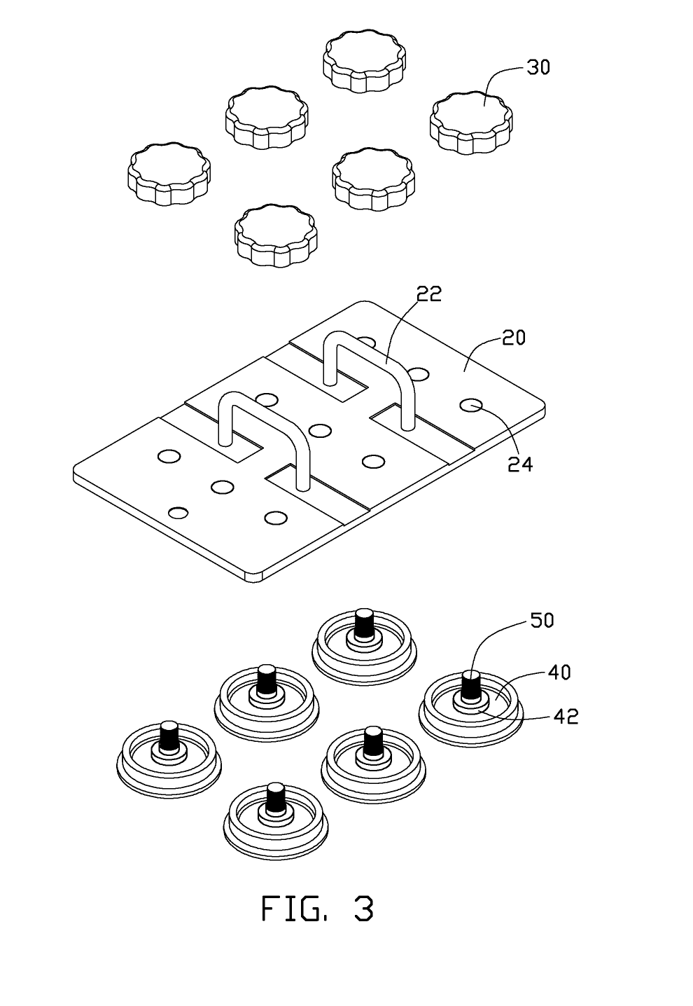

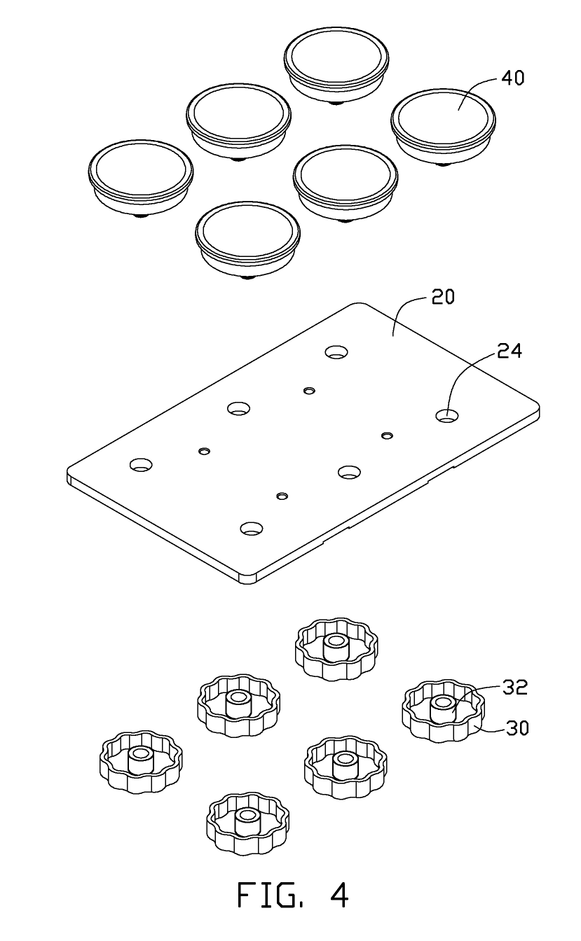

Referring to FIGS. 3 and 4, each suction cup 40 includes a seat 42 protruding from a back side of the suction cup 40. A rod 50 protrudes from the top of each seat 42. Each rod 50 includes an external thread formed on a lateral surface thereof. In the embodiment, the rod 50 is integrally formed on the suction cup 40 by double shot molding. Each fastener 30 includes a sleeve 32 defining a threaded hole. The plate 20 further defines a number of through holes 24.

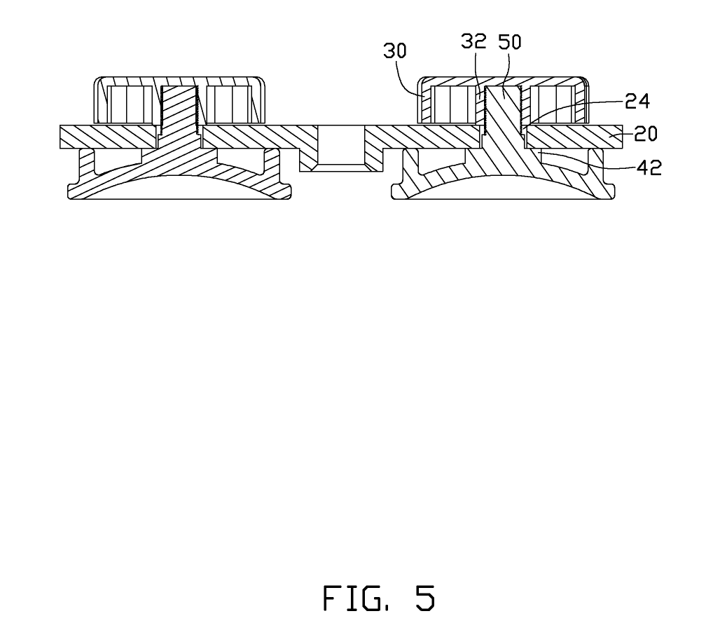

Referring to FIG. 5, the distal end of each rod 50 passes through a corresponding through hole 24 of the plate 20 and is screwed into the threaded hole of the corresponding sleeve 32. The seats 42 and the fasteners 30 respectively abut against opposite sides of the plate 20. When disassembling a cover from an electronic device (not shown), the suction cups 40 are put on the cover and a pushing force is exerted on the handle 22. The suction cups 40 are then deformed and the air in the suction cups 40 is expelled. As a result, the suction cups 40 firmly attach to the cover under vacuum. An operator can then grip the handle 22 to pull the cover until the cover is detached.

It is to be understood, however, that even though numerous characteristics and advantages of the present disclosure have been set forth in the foregoing description, together with details of the structure and function of the present disclosure, the present disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. A disassembly device comprising:
a plate defining a plurality of through holes;
a plurality of fasteners disposed at one side of the plate;
a plurality of suction cups disposed at an opposite side of the plate to the fasteners; and
a plurality of rods fixed to the respective suction cups, the rods extending through the respective through holes, and being connected to the respective fasteners.

2. The disassembly device of claim 1, wherein each of the suction cups comprises a seat protruding from a back side of the suction cup, the rod protrudes from the top of the seat, the seats and the fasteners respectively abut against the opposite sides of the plate.

3. The disassembly device of claim 1, wherein the rod is integrally formed on the suction cup by double shot molding.
